(19) United States
(12) Patent Application Publication
(10) Pub. No.: US 2005/0145326 A1
(43) Pub. Date: Jul. 7, 2005

(54) Method of making an OLED device

(75) Inventor: Tukaram K. Hatwar, Penfield, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/751,389

(22) Filed: Jan. 5, 2004

(51) Int. Cl. B44C 1/165; B44C 1/00

(52) U.S. Cl. 156/230; 156/238

(57) ABSTRACT

A method of making an OLED device includes forming a color filter array over one surface of a substrate; forming by an evaporation process an anode over the second surface of the substrate and a hole-transporting layer over the anode; moving one or more coated donor elements into a transfer position relative to the hole-transporting layer and transferring emissive material from the donor elements onto the hole-transporting layer to form a light-emitting layer which is capable of emitting white light; and coating by an evaporation process a cathode over the light-emitting layer.

### CROSS REFERENCE TO RELATED APPLICATIONS

Reference is made to commonly assigned U.S. patent application Ser. No. 10/021,410 filed Dec. 12, 2001 by Bradley A. Phillips, et al., entitled “Apparatus for Permitting Transfer of Organic Material From a Donor to Form a Layer in an OLED Device”; commonly assigned U.S. patent application Ser. No. 10/224,182 filed Aug. 20, 2002 by Bradley A. Phillips, et al., entitled “Apparatus for Permitting Transfer of Organic Material from a Donor Web to Form a Layer In an OLED Device”; and commonly assigned U.S. patent application Ser. No. 10/647,499 filed Aug. 5, 2003 by Giana M. Phelan, et al., entitled “Correcting Potential Defects in an OLED Device”; the disclosures of which are incorporated herein by reference.

### FIELD OF THE INVENTION

The present invention relates to white OLED devices with color filter arrays, and manufacturing thereof.

### BACKGROUND OF THE INVENTION

An organic light-emitting diode device, also called an OLED device, commonly includes a substrate, an anode, a hole-transporting layer made of an organic compound, an organic luminescent layer with suitable dopants, an organic electron-transporting layer, and a cathode. OLED devices are attractive because of their low driving voltage, high luminance, wide-angle viewing, and capability for full-color flat emission displays. Tang, et al. described this multilayer OLED device in their U.S. Pat. Nos. 4,769,292 and 4,885,211.

Full-color OLED devices can require the deposition of three different colored emitting layers in a very precise pattern. Because this can be a challenging process that adds to cycle time in high-volume manufacturing, there has been increasing interest in filtered white-emitting OLED devices.

A white-emitting electroluminescent (EL) layer can be used to form a multicolor device. Each pixel is coupled with a color filter element as part of a color filter array (CFA) to achieve a pixilated multicolor display. The organic EL layer is common to all pixels and the final color as perceived by the viewer is dictated by that pixel's corresponding color filter element. Therefore a multicolor or RGB device can be produced without requiring any patterning of the organic EL layers. An example of a white CFA top-emitting device is shown in U.S. Pat. No. 6,392,340.

White light-producing OLED devices should be bright, efficient, and generally have Commission International d'Eclairage (CIE) chromaticity coordinates of about (0.33, 0.33). In any event, in accordance with this disclosure, white light is that light which is perceived by a user as having a white color. The following patents and publications disclose the preparation of organic OLED devices capable of producing white light, comprising a hole-transporting layer and an organic luminescent layer, and interposed between a pair of electrodes.

White light-producing OLED devices have been reported before by J. Shi (U.S. Pat. No. 5,683,823) wherein the luminescent layer includes red and blue light-emitting materials uniformly dispersed in a host emitting material. Sato, et al. in JP 07-142169 discloses an OLED device, capable of emitting white light, made by forming a blue light-emitting layer next to the hole-transporting layer and followed by a green light-emitting layer having a region containing a red fluorescent layer.

Kido, et al., in Science, Vol. 267, p. 1332 (1995) and in APL Vol. 64, p. 815 (1994), report a white light-producing OLED device. In this device, three emitter layers with different carrier transport properties, each emitting blue, green, or red light, are used to generate white light. Littman, et al. in U.S. Pat. No. 5,405,709 disclose another white emitting device, which is capable of emitting white light in response to hole-electron recombination, and comprises a fluorescent in a visible light range from bluish green to red. Deshpande, et al., in Applied Physics Letters, Vol. 75, p. 888 (1999), published a white OLED device using red, blue, and green luminescent layers separated by a hole-blocking layer.

There is a need for efficient and low-cost manufacturing methods for white-emitting OLED devices.

### SUMMARY OF THE INVENTION

It is therefore an object of the present invention to provide an efficient manufacturing process for white-emitting OLED devices.

This object is achieved by a method of making a color OLED device comprising:
a) forming a color filter array over one surface of a substrate;
b) forming by an evaporation process an anode over the second surface of the substrate and a hole-transporting layer over the anode;
c) moving one or more coated donor elements into a transfer position relative to the hole-transporting layer and transferring emissive material from the donor elements onto the hole-transporting layer to form a light-emitting layer which is capable of emitting white light; and
d) coating by an evaporation process a cathode over the light-emitting layer.

### ADVANTAGES

It is an advantage of this invention that an OLED device can be manufactured by the use of a donor element without the need of exact positioning required for donor element transfer with some RGB systems, thus increasing efficiency and reducing cycle time and cost in manufacturing. It is a further advantage that a donor element can be analyzed before being used for transfer, thus preventing formation of a substandard OLED device. It is a further advantage of this invention that it can be used with light-emitting materials which cannot readily undergo evaporative transfer, e.g. polymeric materials for a white OLED device. It is a further advantage that this invention can be used in the manufacture of OLED devices that include RGBW arrays. It is a further advantage of this invention that an OLED device can use a light-emitting layer with a larger tolerance in concentration of the layer components.

### BRIEF DESCRIPTION OF THE DRAWINGS

FIG. 1 is a cross-sectional view of an OLED device that can be prepared according to a first embodiment of this invention;

FIG. 2 shows a cross-sectional view of the structure of a donor element that can be used in this invention;

FIG. 3 shows a cross-sectional view of one embodiment of an apparatus for use in this invention wherein heat-transferable emissive material can be transferred to a flexible donor support, and the resulting donor element can be moved into a transfer position relative to an OLED substrate so that emissive material can be transferred to the substrate;

FIG. 4 shows a cross-sectional view of another embodiment of an apparatus for use in this invention wherein the donor element is a web that can be moved into a transfer position relative to an OLED substrate so that emissive material can be transferred to the substrate; and

FIG. 5 is a block diagram of one embodiment of a method of practicing this invention.

Since device feature dimensions such as layer thicknesses are frequently in sub-micrometer ranges, the drawings are scaled for ease of visualization rather than dimensional accuracy.

### DETAILED DESCRIPTION OF THE INVENTION

The term “pixel” is employed in its art-recognized usage to designate an area of a display panel that can be stimulated to emit light independently of other areas. The term “OLED device” or “organic light-emitting display” is used in its art-recognized meaning of a display device comprising organic light-emitting diodes as pixels. A color OLED device emits light of at least one color. The term “multicolor” is employed to describe a display panel that is capable of emitting light of a different hue in different areas. In particular, it is employed to describe a display panel that is capable of displaying images of different colors. These areas are not necessarily contiguous. The term “full color” is employed to describe multicolor display panels that are capable of emitting in the red, green, and blue regions of the visible spectrum and displaying images in any combination of hues. The red, green, and blue colors constitute the three primary colors from which all other colors can be generated by appropriate mixing. The term “hue” refers to the intensity profile of light emission within the visible spectrum, with different hues exhibiting visually discernible differences in color. The pixel or subpixel is generally used to designate the smallest addressable unit in a display panel. For a monochrome display, there is no distinction between pixel or subpixel. The term “subpixel” is used in multicolor display panels and is employed to designate any portion of a pixel which can be independently addressable to emit a specific color. For example, a blue subpixel is that portion of a pixel which can be addressed to emit blue light. In a full-color display, a pixel generally comprises three primary-color subpixels, namely blue, green, and red. The term “pitch” is used to designate the distance separating two pixels or subpixels in a display panel. Thus, a subpixel pitch means the separation between two subpixels.

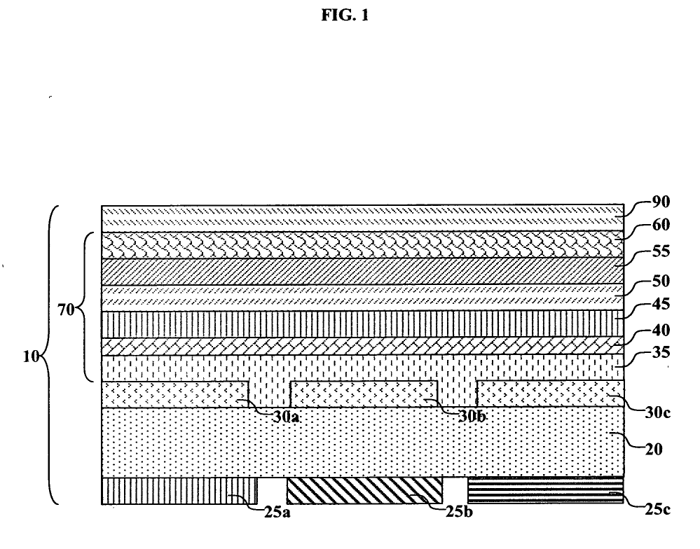

Turning now to FIG. 1, there is shown a cross-sectional view of a pixel of a light-emitting color OLED device 10 that can be prepared according to a first embodiment of the present invention. OLED device 10 includes at a minimum a substrate 20, anodes 30a, 30b, and 30c (one anode for each subpixel), a cathode 90 spaced from the anodes, a light-emitting layer 50, and a color filter array. The color filter array includes a series of separate filters, e.g. red color filter 25a, green color filter 25b, and blue color filter 25c, each of which forms part of a red, green, and blue subpixel respectively. Each subpixel has its own anode 30a, 30b, and 30c, respectively, which are capable of independently causing emission of the individual subpixel. OLED device 10 can also include a hole-injecting layer 35, a hole-transporting layer 40, a second light-emitting layer 45, an electron-transporting layer 55, and an electron-injecting layer 60. Hole-injecting layer 35, hole-transporting layer 40, light-emitting layers 45 and 50, electron-transporting layer 55, and electron-injecting layer 60 comprise organic EL element 70 that is disposed between anode 30 and cathode 90 and that for the purposes of this invention includes at least two different dopants for collectively emitting white light. These components will be described in more detail.

Substrate 20 can be an organic solid, an inorganic solid, or include organic and inorganic solids. Substrate 20 can be rigid or flexible and can be processed as separate individual pieces, such as sheets or wafers, or as a continuous roll. Typical substrate materials include glass, plastic, metal, ceramic, semiconductor, metal oxide, semiconductor oxide, semiconductor nitride, or combinations thereof. Substrate 20 can be a homogeneous mixture of materials, a composite of materials, or multiple layers of materials. Substrate 20 can be an OLED substrate, that is a substrate commonly used for preparing OLED devices, e.g. active-matrix low-temperature polysilicon or amorphous-silicon TFT substrate. The substrate 20 can either be light transmissive or opaque, depending on the intended direction of light emission. The light transmissive property is desirable for viewing the EL emission through the substrate. Transparent glass or plastic are commonly employed in such cases. For applications where the EL emission is viewed through the top electrode, the transmissive characteristic of the bottom support is immaterial, and therefore can be light transmissive, light absorbing or light reflective. Substrates for use in this case include, but are not limited to, glass, plastic, semiconductor materials, ceramics, and circuit board materials, or any others commonly used in the formation of OLED devices, which can be either passive-matrix devices or active-matrix devices.

The color filters 25a, 25b, and 25c include color filter elements for the color to be emitted from the subpixels of OLED device 10 and are part of a color filter array that is disposed over organic EL element 70. The color filters are constructed to pass a preselected color of light in response to white light, so as to produce a preselected color output for each subpixel. An array of three different kinds of color filters 25a, 25b, and 25c that pass red, green, and blue light, respectively, is particularly useful in a full color OLED device. Another arrangement known to be useful includes a fourth subpixel wherein a lack of a color filter permits emission of the full spectrum from the OLED device, such an arrangement is commonly known as an RGBW device. Several types of color filters are known in the art. One type of color filter is formed on a second transparent substrate and then aligned with the pixels of the first substrate 20. An alternative type of color filter is formed directly over the elements of OLED device 10. The space between the individual color filter elements can also be filled with a black matrix (not shown) to reduce pixel cross talk and improve the display's contrast. While the color filters 25a, 25b, and 25c forming the color filter array are shown here as being formed over one surface of substrate 20 and the anodes 30a, 30b, and 30c, respectively, formed over the second surface of substrate 20, the color filters can alternatively be located between substrate 20 and the corresponding anode. For a top-emitting device, the color filters can be located over cathode 90.

An electrode is formed over substrate 20 and is most commonly configured as an anode, e.g. anodes 30a, 30b, and 30c. When EL emission is viewed through the substrate 20, anode layers 30a, 30b, and 30c be transparent or substantially transparent to the emission of interest. Common transparent anode materials useful in this invention are indium-tin oxide and tin oxide, but other metal oxides can work including, but not limited to, aluminum- or indium-doped zinc oxide, magnesium-indium oxide, and nickel-tungsten oxide. In addition to these oxides, metal nitrides such as gallium nitride, metal selenides such as zinc selenide, and metal sulfides such as zinc sulfide, can be used as an anode material. For applications where EL emission is viewed through the top electrode, the transmissive characteristics of the anode material are immaterial and any conductive material can be used, transparent, opaque or reflective. Example conductors for this application include, but are not limited to, gold, iridium, molybdenum, palladium, and platinum. The preferred anode materials, transmissive or otherwise, have a work function of 4.1 eV or greater. Desired anode materials can be deposited by any suitable way such as evaporation, sputtering, chemical vapor deposition, or electrochemical means. Anode materials can be patterned using well known photolithographic processes.

While not always necessary, it is often useful that a hole-injecting layer 35 be formed over anodes 30a, 30b, and 30c in an organic light-emitting display. The hole-injecting material can serve to improve the film formation property of subsequent organic layers and to facilitate injection of holes into the hole-transporting layer. Suitable materials for use in hole-injecting layer 35 include, but are not limited to, porphyrinic compounds as described in U.S. Pat. No. 4,720,432, plasma-deposited fluorocarbon polymers as described in U.S. Pat. No. 6,208,075, and inorganic oxides including vanadium oxide (VOx), molybdenum oxide (MoOx), nickel oxide (NiOx), etc. Alternative hole-injecting materials reportedly useful in organic EL devices are described in EP 0 891 121 A1 and EP 1 029 909 A1.

While not always necessary, it is often useful that a hole-transporting layer 40 be formed and disposed over anodes 30a, 30b, and 30c. Desired hole-transporting materials can be deposited by any suitable way such as evaporation, sputtering, chemical vapor deposition, electrochemical means, thermal transfer, or laser thermal transfer from a donor material. Hole-transporting materials useful in hole-transporting layer 40 are well known to include compounds such as an aromatic tertiary amine, where the latter is understood to be a compound containing at least one trivalent nitrogen atom that is bonded only to carbon atoms, at least one of which is a member of an aromatic ring. In one form the aromatic tertiary amine can be an arylamine, such as a monoarylamine, diarylamine, triarylamine, or a polymeric arylamine. Exemplary monomeric triarylamines are illustrated by Klupfel, et al. in U.S. Pat. No. 3,180,730. Other suitable triarylamines substituted with one or more vinyl radicals and/or comprising at least one active hydrogen-containing group are disclosed by Brantley, et al. in U.S. Pat. Nos. 3,567,450 and 3,658,520.

A more preferred class of aromatic tertiary amines are those which include at least two aromatic tertiary amine moieties as described in U.S. Pat. Nos. 4,720,432 and 5,061,569. Such compounds include those represented by structural Formula A 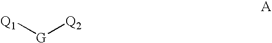
wherein:
Q₁ and Q₂ are independently selected aromatic tertiary amine moieties; and
G is a linking group such as an arylene, cycloalkylene, or alkylene group of a carbon to carbon bond.

In one embodiment, at least one of Q1 or Q2 contains a polycyclic fused ring structure, e.g., a naphthalene. When G is an aryl group, it is conveniently a phenylene, biphenylene, or naphthalene moiety.

A useful class of triarylamines satisfying structural Formula A and containing two triarylamine moieties is represented by structural Formula B 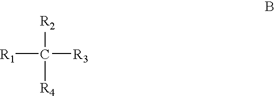
where:
R₁ and R₂ each independently represent a hydrogen atom, an aryl group, or an alkyl group or R₁ and R₂ together represent the atoms completing a cycloalkyl group; and
R₃ and R₄ each independently represent an aryl group, which is in turn substituted with a diaryl substituted amino group, as indicated by structural Formula C 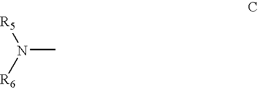
   wherein R₅ and R₆ are independently selected aryl groups. In one embodiment, at least one of R₅ or R₆ contains a polycyclic fused ring structure, e.g., a naphthalene.

Another class of aromatic tertiary amines are the tetraaryldiamines. Desirable tetraaryldiamines include two diarylamino groups, such as indicated by Formula C, linked through an arylene group. Useful tetraaryldiamines include those represented by Formula D 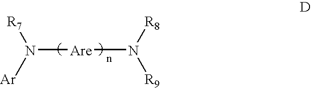
wherein:
each Are is an independently selected arylene group, such as a phenylene or anthracene moiety;
n is an integer of from 1 to 4; and
Ar, R₇, R₈, and R₉ are independently selected aryl groups.

In a typical embodiment, at least one of Ar, R₇, R₈, and R₉ is a polycyclic fused ring structure, e.g., a naphthalene.

The various alkyl, alkylene, aryl, and arylene moieties of the foregoing structural Formulae A, B, C, D, can each in turn be substituted. Typical substituents include alkyl groups, alkoxy groups, aryl groups, aryloxy groups, and halogens such as fluoride, chloride, and bromide. The various alkyl and alkylene moieties typically contain from 1 to about 6 carbon atoms. The cycloalkyl moieties can contain from 3 to about 10 carbon atoms, but typically contain five, six, or seven carbon atoms—e.g., cyclopentyl, cyclohexyl, and cycloheptyl ring structures. The aryl and arylene moieties are usually phenyl and phenylene moieties.

The hole-transporting layer in an OLED device can be formed of a single or a mixture of aromatic tertiary amine compounds. Specifically, one can employ a triarylamine, such as a triarylamine satisfying Formula B, in combination with a tetraaryldiamine, such as indicated by Formula D. When a triarylamine is employed in combination with a tetraaryldiamine, the latter is positioned as a layer interposed between the triarylamine and the electron-injecting and transporting layer. Illustrative of useful aromatic tertiary amines are the following:
1,1-Bis(4-di-p-tolylaminophenyl)cyclohexane;
1,1-Bis(4-di-p-tolylaminophenyl)-4-phenylcyclohexane;
4,4′-Bis(diphenylamino)quadriphenyl;
Bis(4-dimethylamino-2-methylphenyl)-phenylmethane;
N,N,N-Tri(p-tolyl)amine;
4-(di-p-tolylamino)-4′-[4(di-p-tolylamino)-styryl]stilbene;
N,N,N′,N′-Tetra-p-tolyl-4-4′-diaminobiphenyl;
N,N,N′,N′-Tetraphenyl-4,4′-diaminobiphenyl;
N-Phenylcarbazole;
Poly(N-vinylcarbazole);
N,N′-di-1-naphthalenyl-N,N′-diphenyl-4,4′-diaminobiphenyl;
4,4′-Bis[N-(1-naphthyl)-N-phenylamino]biphenyl;
4,4″-Bis[N-(1-naphthyl)-N-phenylamino]ₚ-terphenyl;
4,4′-Bis[N-(2-naphthyl)-N-phenylamino]biphenyl;
4,4′-Bis[N-(3-acenaphthenyl)-N-phenylamino]biphenyl;
1,5-Bis[N-(1-naphthyl)-N-phenylamino]naphthalene;
4,4′-Bis[N-(9-anthryl)-N-phenylamino]biphenyl;
4,4″-Bis[N-(1-anthryl)-N-phenylamino]-p-terphenyl;
4,4′-Bis[N-(2-phenanthryl)-N-phenylamino]biphenyl;
4,4′-Bis[N-(8-fluoranthenyl)-N-phenylamino]biphenyl;
4,4′-Bis[N-(2-pyrenyl)-N-phenylamino]biphenyl;
4,4′-Bis[N-(2-naphthacenyl)-N-phenylamino]biphenyl;
4,4′-Bis[N-(2-perylenyl)-N-phenylamino]biphenyl;
4,4′-Bis[N-(1-coronenyl)-N-phenylamino]biphenyl;
2,6-Bis(di-p-tolylamino)naphthalene;
2,6-Bis[di-(1-naphthyl)amino]naphthalene;
2,6-Bis[N-(1-naphthyl)-N-(2-naphthyl)amino]naphthalene;
N,N,N′,N′-Tetra(2-naphthyl)-4,4″-diamino-p-terphenyl;
4,4′-Bis {N-phenyl-N-[4-(1-naphthyl)-phenyl]amino} biphenyl;
4,4′-Bis[N-phenyl-N-(2-pyrenyl)amino]biphenyl;
2,6-Bis[N,N-di(2-naphthyl)amine]fluorene; and
1,5-Bis[N-(1-naphthyl)-N-phenylamino]naphthalene.

Another class of useful hole-transporting materials includes polycyclic aromatic compounds as described in EP 1 009 041. In addition, polymeric hole-transporting materials can be used such as poly(N-vinylcarbazole) (PVK), polythiophenes, polypyrrole, polyaniline, and copolymers such as poly(3,4-ethylenedioxythiophene)/poly(4-styrenesulfonate) also called PEDOT/PSS.

Light-emitting layer 50 (and light-emitting layer 45, if present) produces light in response to hole-electron recombination. Light-emitting layer 50 is commonly disposed over hole-transporting layer 40. Desired organic light-emitting materials can be deposited by any suitable way such as evaporation, sputtering, chemical vapor deposition, electrochemical means, or radiation thermal transfer from a donor material. Useful organic light-emitting materials are well known. As more fully described in U.S. Pat. Nos. 4,769,292 and 5,935,721, the light-emitting layers of the organic EL element comprise a luminescent or fluorescent material where electroluminescence is produced as a result of electron-hole pair recombination in this region. The light-emitting layers can be comprised of a single material, but more commonly include a host material doped with a guest compound or dopant where light emission comes primarily from the dopant. The dopant is selected to produce color light having a particular spectrum. The host materials in the light-emitting layers can be an electron-transporting material, as defined below, a hole-transporting material, as defined above, or another material that supports hole-electron recombination. The dopant is usually chosen from highly fluorescent dyes, but phosphorescent compounds, e.g., transition metal complexes as described in WO 98/55561, WO 00/18851, WO 00/57676, and WO 00/70655 are also useful. Dopants are typically coated as 0.01 to 10% by weight into the host material.

An important relationship for choosing a dye as a dopant is a comparison of the bandgap potential which is defined as the energy difference between the highest occupied molecular orbital and the lowest unoccupied molecular orbital of the molecule. For efficient energy transfer from the host material to the dopant molecule, a necessary condition is that the band gap of the dopant is smaller than that of the host material.

Host and emitting molecules known to be of use include, but are not limited to, those disclosed in U.S. Pat. Nos. 4,768,292; 5,141,671; 5,150,006; 5,151,629; 5,294,870; 5,405,709; 5,484,922; 5,593,788; 5,645,948; 5,683,823; 5,755,999; 5,928,802; 5,935,720; 5,935,721; and 6,020,078.

Metal complexes of 8-hydroxyquinoline and similar derivatives (Formula E) constitute one class of useful host materials capable of supporting electroluminescence, and are particularly suitable for light emission of wavelengths longer than 500 nm, e.g., green, yellow, orange, and red. 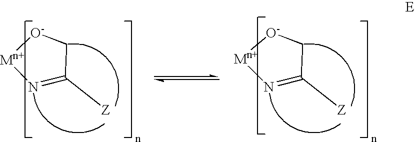
wherein:
M represents a metal;
n is an integer of from 1 to 3; and
Z independently in each occurrence represents the atoms completing a nucleus having at least two fused aromatic rings.

From the foregoing it is apparent that the metal can be a monovalent, divalent, or trivalent metal. The metal can, for example, be an alkali metal, such as lithium, sodium, or potassium; an alkaline earth metal, such as magnesium or calcium; or an earth metal, such as boron or aluminum. Generally any monovalent, divalent, or trivalent metal known to be a useful chelating metal can be employed.

Z completes a heterocyclic nucleus containing at least two fused aromatic rings, at least one of which is an azole or azine ring. Additional rings, including both aliphatic and aromatic rings, can be fused with the two required rings, if required. To avoid adding molecular bulk without improving on function the number of ring atoms is usually maintained at 18 or less.

Illustrative of useful chelated oxinoid compounds are the following:
CO-1: Aluminum trisoxine [alias, tris(8-quinolinolato)aluminum(III)]
CO-2: Magnesium bisoxine [alias, bis(8-quinolinolato)magnesium(II)]
CO-3: Bis[benzo {f}-8-quinolinolato]zinc (II)
CO-4: Bis(2-methyl-8-quinolinolato)aluminum(III)-μ-oxo-bis(2-methyl-8-quinolinolato) aluminum(III)
CO-5: Indium trisoxine [alias, tris(8-quinolinolato)indium]
CO-6: Aluminum tris(5-methyloxine) [alias, tris(5-methyl-8-quinolinolato) aluminum(III)]
CO-7: Lithium oxine [alias, (8-quinolinolato)lithium(I)]
CO-8: Gallium oxine [alias, tris(8-quinolinolato)gallium(III)]
CO-9: Zirconium oxine [alias, tetra(8-quinolinolato)zirconium(IV)]

The host material in light-emitting layer 50 can be an anthracene derivative having hydrocarbon or substituted hydrocarbon substituents at the 9 and 10 positions. For example, derivatives of 9,10-di-(2-naphthyl)anthracene (Formula F) constitute one class of useful host materials capable of supporting electroluminescence, and are particularly suitable for light emission of wavelengths longer than 400 nm, e.g., blue, green, yellow, orange or red.

| | |
|---|---|
| F | 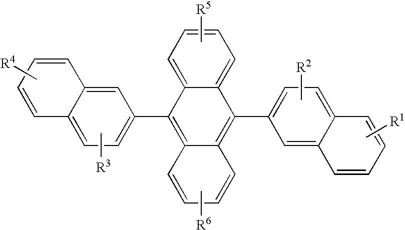 |

wherein R¹, R², R³, R⁴, R⁵, and R⁶ represent one or more substituents on each ring where each substituent is individually selected from the following groups:
Group 1: hydrogen, or alkyl of from 1 to 24 carbon atoms;
Group 2: aryl or substituted aryl of from 5 to 20 carbon atoms;
Group 3: carbon atoms from 4 to 24 necessary to complete a fused aromatic ring of anthracenyl, pyrenyl, or perylenyl;
Group 4: heteroaryl or substituted heteroaryl of from 5 to 24 carbon atoms as necessary to complete a fused heteroaromatic ring of furyl, thienyl, pyridyl, quinolinyl or other heterocyclic systems;
Group 5: alkoxylamino, alkylamino, or arylamino of from 1 to 24 carbon atoms; and
Group 6: fluorine, chlorine, bromine or cyano.

Benzazole derivatives (Formula G) constitute another class of useful host materials capable of supporting electroluminescence, and are particularly suitable for light emission of wavelengths longer than 400 nm, e.g., blue, green, yellow, orange or red. 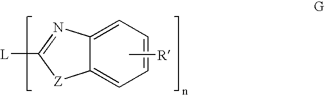
where:
n is an integer of 3 to 8;
Z is O, NR or S;
R′ is hydrogen; alkyl of from 1 to 24 carbon atoms, for example, propyl, t-butyl, heptyl, and the like; aryl or heteroatom substituted aryl of from 5 to 20 carbon atoms for example phenyl and naphthyl, furyl, thienyl, pyridyl, quinolinyl and other heterocyclic systems; or halo such as chloro, fluoro; or atoms necessary to complete a fused aromatic ring; and
L is a linkage unit including alkyl, aryl, substituted alkyl, or substituted aryl, which conjugately or unconjugately connects the multiple benzazoles together.

An example of a useful benzazole is 2, 2′, 2″-(1,3,5-phenylene)tris[1-phenyl-1H-benzimidazole].

Desirable fluorescent dopants include perylene or derivatives of perylene, derivatives of anthracene, tetracene, xanthene, rubrene, coumarin, rhodamine, quinacridone, dicyanomethylenepyran compounds, thiopyran compounds, polymethine compounds, pyrilium and thiapyrilium compounds, derivatives of distryrylbenzene or distyrylbiphenyl, bis(azinyl)methane boron complex compounds, and carbostyryl compounds. Illustrative examples of useful dopants include, but are not limited to, the following:

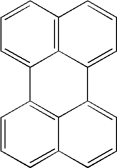

L1

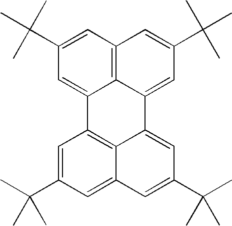

L2

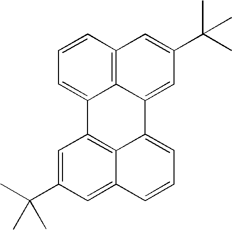

L3

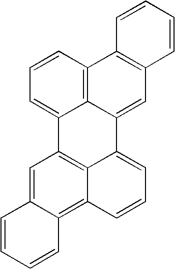

L4

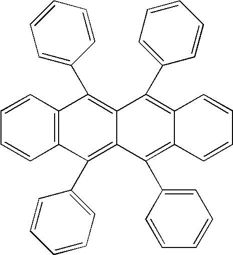

L5

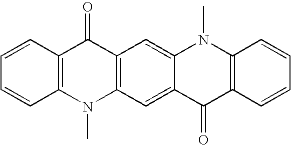

L6

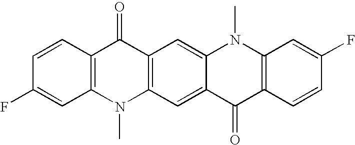

L7

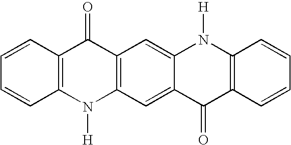

L8

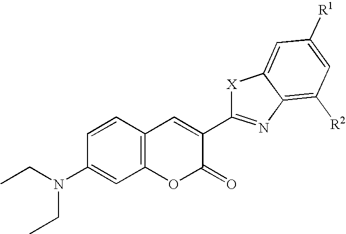

| | X | R1 | R2 |
|---|---|---|---|
| L9 | O | H | H |
| L10 | O | H | Methyl |
| L11 | O | Methyl | H |
| L12 | O | Methyl | Methyl |
| L13 | O | H | t-butyl |
| L14 | O | t-butyl | H |
| L15 | O | t-butyl | t-butyl |
| L16 | S | H | H |
| L17 | S | H | Methyl |
| L18 | S | Methyl | H |
| L19 | S | Methyl | Methyl |
| L20 | S | H | t-butyl |
| L21 | S | t-butyl | H |
| L22 | S | t-butyl | t-butyl |

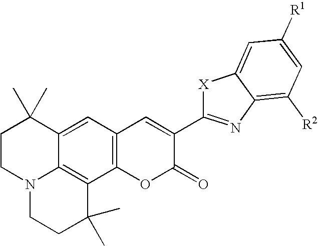

| | X | R1 | R2 |
|---|---|---|---|
| L23 | O | H | H |
| L24 | O | H | Methyl |
| L25 | O | Methyl | H |
| L26 | O | Methyl | Methyl |
| L27 | O | H | t-butyl |
| L28 | O | t-butyl | H |
| L29 | O | t-butyl | t-butyl |
| L30 | S | H | H |
| L31 | S | H | Methyl |
| L32 | S | Methyl | H |
| L33 | S | Methyl | Methyl |
| L34 | S | H | t-butyl |
| L35 | S | t-butyl | H |
| L36 | S | t-butyl | t-butyl |

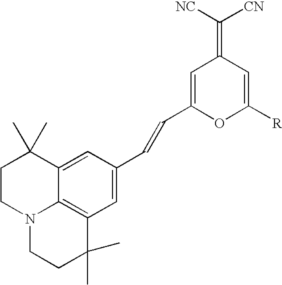

| | R |
|---|---|
| L37 | phenyl |
| L38 | methyl |
| L39 | t-butyl |
| L40 | mesityl |

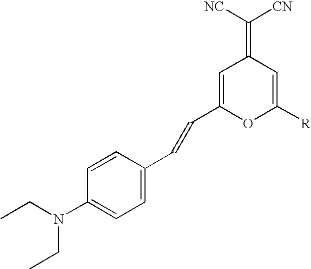

| | R |
|---|---|
| L41 | phenyl |
| L42 | methyl |
| L43 | t-butyl |
| L44 | mesityl |

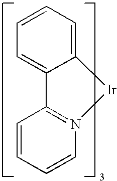

L45

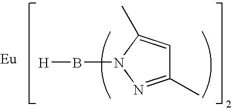

L46

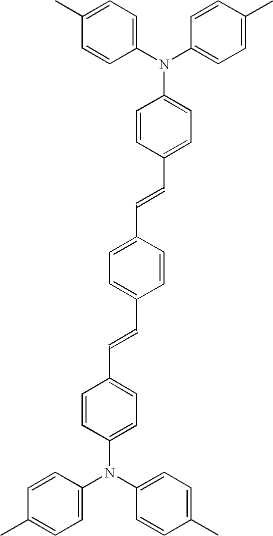

L47

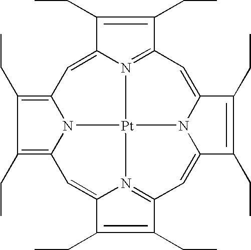

L48

Other organic emissive materials can be polymeric substances, e.g. polyphenylenevinylene derivatives, dialkoxy-polyphenylenevinylenes, poly-para-phenylene derivatives, and polyfluorene derivatives, as taught by Wolk, et al. in commonly assigned U.S. Pat. No. 6,194,119 B 1 and references cited therein.

While not always necessary, it is often useful that OLED device 10 includes an electron-transporting layer 55 disposed over light-emitting layer 50. Desired electron-transporting materials can be deposited by any suitable way such as evaporation, sputtering, chemical vapor deposition, electrochemical means, thermal transfer, or laser thermal transfer from a donor material. Preferred electron-transporting materials for use in electron-transporting layer 55 are metal chelated oxinoid compounds, including chelates of oxine itself (also commonly referred to as 8-quinolinol or 8-hydroxyquinoline). Such compounds help to inject and transport electrons and exhibit both high levels of performance and are readily fabricated in the form of thin films. Exemplary of contemplated oxinoid compounds are those satisfying structural Formula E, previously described.

Other electron-transporting materials include various butadiene derivatives as disclosed in U.S. Pat. No. 4,356,429 and various heterocyclic optical brighteners as described in U.S. Pat. No. 4,539,507. Benzazoles satisfying structural Formula G are also useful electron-transporting materials.

Other electron-transporting materials can be polymeric substances, e.g. polyphenylenevinylene derivatives, poly-para-phenylene derivatives, polyfluorene derivatives, polythiophenes, polyacetylenes, and other conductive polymeric organic materials such as those listed in Handbook of Conductive Molecules and Polymers, Vols. 1-4, H. S. Nalwa, ed., John Wiley and Sons, Chichester (1997).

It will be understood that, as is common in the art, some of the layers can have more than one function. For example, light-emitting layer 45 can be a hole-transporting layer that includes light-emitting dopants. Light-emitting layer 50 can have hole-transporting properties or electron-transporting properties as desired for performance of the OLED device. Hole-transporting layer 40 or electron-transporting layer 55, or both, can also have light-emitting properties. In such a case, fewer layers than described above can be sufficient for the desired emissive properties.

The organic EL media materials mentioned above are suitably deposited through an evaporation process such as sublimation, but can be deposited from a fluid, for example, from a solvent with an optional binder to improve film formation. If the material is a polymer, solvent deposition is useful but other methods can be used, such as sputtering or thermal transfer from a donor element. The material to be deposited by sublimation can be vaporized from a sublimator “boat” often comprised of a tantalum material, e.g., as described in U.S. Pat. No. 6,237,529, or can be first coated onto a donor support and then sublimed in closer proximity to the substrate. Layers with a mixture of materials can utilize separate sublimator boats or the materials can be pre-mixed and coated from a single boat or donor element. As will be seen, for the purposes of this invention, coating from a donor element is preferred for the light-emitting layers.

An electron-injecting layer 60 can also be present between the cathode and the electron-transporting layer. Examples of electron-injecting materials include alkaline or alkaline earth metals, alkali halide salts, such as LiF mentioned above, or alkaline or alkaline earth metal doped organic layers.

Cathode 90 is formed over the electron-transporting layer 55 or over light-emitting layer 50 if an electron-transporting layer is not used. When light emission is through the anodes, the cathode material can be comprised of nearly any conductive material. Desirable materials have good film-forming properties to ensure good contact with the underlying organic layer, promote electron injection at low voltage, and have good stability. Useful cathode materials often contain a low work function metal (<3.0 eV) or metal alloy. One preferred cathode material is comprised of a Mg:Ag alloy wherein the percentage of silver is in the range of 1 to 20%, as described in U.S. Pat. No. 4,885,221. Another suitable class of cathode materials includes bilayers comprised of a thin layer of a low work function metal or metal salt capped with a thicker layer of conductive metal. One such cathode is comprised of a thin layer of LiF followed by a thicker layer of A1 as described in U.S. Pat. No. 5,677,572. Other useful cathode materials include, but are not limited to, those disclosed in U.S. Pat. Nos. 5,059,861; 5,059,862; and 6,140,763.

When light emission is viewed through cathode 90, it must be transparent or nearly transparent. For such applications, metals must be thin or one must use transparent conductive oxides, or include these materials. Optically transparent cathodes have been described in more detail in U.S. Pat. No. 5,776,623. Cathode materials can be deposited by evaporation, sputtering, or chemical vapor deposition. When needed, patterning can be achieved through many well known methods including, but not limited to, through-mask deposition, integral shadow masking as described in U.S. Pat. No. 5,276,380 and EP 0 732 868, laser ablation, and selective chemical vapor deposition.

Cathode 90 is spaced, by which is meant it is vertically spaced apart from anodes 30a, 30b, and 30c. Cathode 90 can be part of an active matrix device and in that case is a single electrode for the entire display. Alternatively, cathode 90 can be part of a passive matrix device, in which each cathode 90 can activate a column of pixels, and cathodes 90 are arranged orthogonal to anodes 30a, 30b, and 30c.

Cathode materials can be deposited by evaporation, sputtering, or chemical vapor deposition. When needed, patterning can be achieved through many well known methods including, but not limited to, through-mask deposition, integral shadow masking as described in U.S. Pat. No. 5,276,380 and EP 0 732 868, laser ablation, and selective chemical vapor deposition.

OLED device 10 is configured such that it is a white light-emitting OLED device. As such, it can include a single white light-emitting layer or a series of two or more light-emitting layers whose combined emission forms white light. There are numerous configurations of the organic EL element 70 layers wherein the present invention can be successfully practiced. Examples of organic EL element layers that produce white light are described, for example, in EP 1 187 235; U.S. Patent Application Publication 2002/0025419 A1; EP 1 182 244; and U.S. Pat. Nos. 5,683,823; 5,503,910; 5,405,709; and 5,283,182. As shown in EP 1 187 235A2, a white light-emitting organic EL element with a substantially continuous spectrum in the visible region of the spectrum can be achieved by providing at least two different dopants for collectively emitting white light, e.g. by the inclusion of the following layers:
a hole-injecting layer 35 disposed over the anode;
a hole-transporting layer 40 that is disposed over the hole-injecting layer 35 and is doped with a light-emitting yellow dopant for emitting light in the yellow region of the spectrum;
a blue light-emitting layer 50 including a host material and a light-emitting blue dopant disposed over the hole-transporting layer 40; and
an electron-transporting layer 55.

Because such an emitter produces a wide range of wavelengths, it can also be known as a broadband emitter and the resulting emitted light known as broadband light.

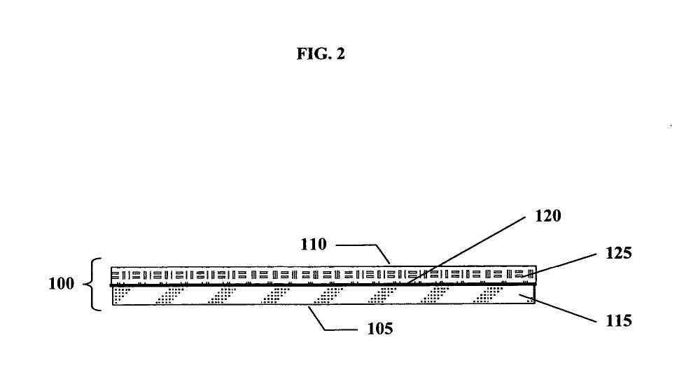

FIG. 2 shows a cross-sectional view of one embodiment of the structure of a coated donor element 100 that can be used in this invention. Donor element 100 includes a flexible donor support 115, which comprises non-transfer surface 105, and a layer formed over donor support 115. The donor support 115 can be made of any of several materials which meet at least the following requirements. The donor support must be capable of maintaining the structural integrity during the light-to-heat-induced transfer step while pressurized on one side, and during any preheating steps contemplated to remove volatile constituents such as water vapor. Additionally, the donor support must be capable of receiving on one surface a relatively thin coating of organic donor material, and of retaining this coating without degradation during anticipated storage periods of the coated support. Support materials meeting these requirements include, for example, metal foils, certain plastic foils which exhibit a glass transition temperature value higher than a support temperature value anticipated to cause transfer of the transferable organic donor materials of the coating on the support, and fiber-reinforced plastic foils. While selection of suitable support materials can rely on known engineering approaches, it will be appreciated that certain aspects of a selected support material merit further consideration when configured as a donor support useful in the practice of the invention. For example, the support can require a multi-step cleaning and surface preparation process prior to precoating with transferable organic material.

If the support material is a radiation-transmissive material, the incorporation into the support or onto a surface thereof, of a radiation-absorptive material can be advantageous to more effectively heat the donor support and to provide a correspondingly enhanced transfer of transferable organic emissive material from the support to the substrate, when using a flash of radiation from a suitable flash lamp or laser light from a suitable laser. In such a case, donor support 115 is first uniformly coated with radiation-absorbing material 120 capable of absorbing radiation in a predetermined portion of the spectrum to produce heat. Radiation-absorbing material 120 is capable of absorbing radiation in a predetermined portion of the spectrum and producing heat. Radiation-absorbing material 120 can be a dye such as the dyes specified in U.S. Pat. No. 5,578,416, a pigment such as carbon, or a metal such as nickel, titanium, etc.

Donor support 115 has been uniformly coated with transferable emissive material 125, which comprises transfer surface 110. Emissive material 125 can include a hole-transporting material, an electron-transporting material, or a host material, if such are doped as above with one or more dopants to have emissive properties. Although emissive material 125 is shown as a single layer, it can in some embodiments include two or more colorant components as desired for the performance of the desired light-emitting layers. For example, a first layer of emissive material 125 can include a light-emitting yellow dopant, while a second layer of emissive material 125 can include a light-emitting blue dopant. Together, the two layers can form a white light-emitting OLED device.

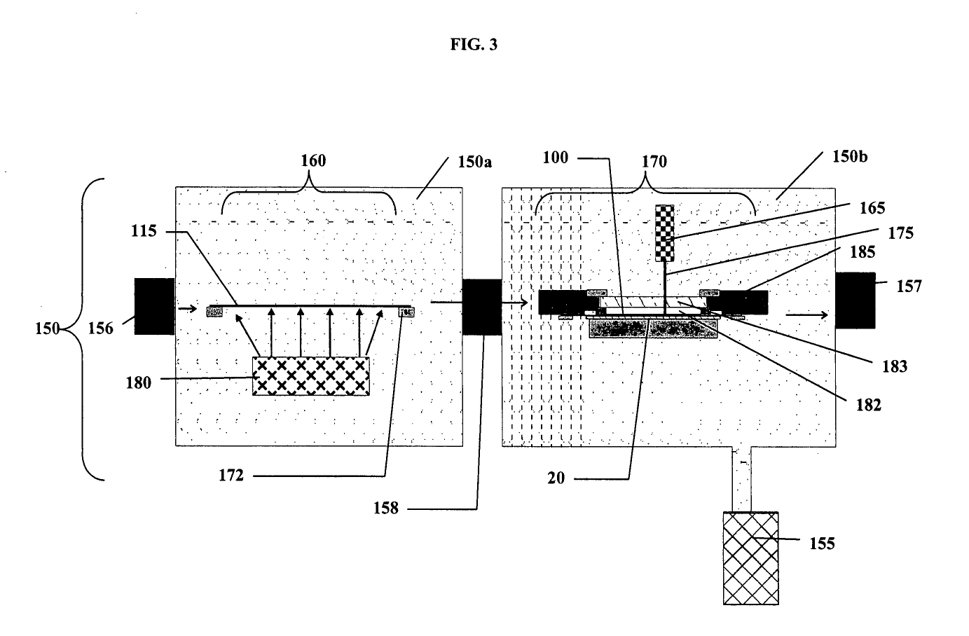

Turning now to FIG. 3, we see a cross-sectional representation of one embodiment of an apparatus for use in this invention wherein heat-transferable emissive materials, e.g. emissive material 125, can be transferred to a flexible donor support, and the resulting donor element can be moved into a transfer position relative to an OLED substrate so that emissive material can be transferred to the substrate. Vacuum coater 150 in this embodiment includes coating chamber 150a and transfer chamber 150b. Both are held under vacuum by vacuum pump 155 and are connected by load lock 158. Vacuum coater 150 includes load lock 156, which is used to load the chamber with fresh uncoated donor support 115. Vacuum coater 150 also includes load lock 157, which is used to unload used donor elements 100. The interior of vacuum coater 150 includes coating station 160 in coating chamber 150a and transfer station 170 in transfer chamber 150b.

Donor support 115 is introduced to coating chamber 150a of vacuum coater 150 by means of load lock 156. Donor support 115 can optionally be supported by supports 172. Donor support 115 is transferred by mechanical means to coating station 160, which includes coating apparatus 180. Coating apparatus 180 is activated (e.g. desired coating material is heated to vaporize it) and donor support 115 is coated evenly with emissive material, rendering it into donor element 100, which is a coated donor support.

Substrate 20 is introduced to transfer chamber 150b of vacuum coater 150 by way of load lock 157 and transferred by mechanical means to transfer apparatus 185. This can occur before, after, or during the introduction of donor support 115. Transfer apparatus 185 is shown for convenience in the closed configuration, but it also has an open configuration in which the donor element 100 and substrate 20 loading and unloading occur. Donor element 100 is transferred by mechanical means from coating station 160 through load lock 158 to transfer station 170. Donor element 100 and substrate 20 are moved into a transfer position, that is, the coated side of donor element 100 is placed in close contact with the receiving surface of substrate 20 and held in place by means such as fluid pressure in pressure chamber 182, as described by commonly assigned U.S. patent application Ser. No. 10/021,410 filed Dec. 12, 2001 by Bradley A. Phillips, et al., entitled “Apparatus for Permitting Transfer of Organic Material From a Donor to Form a Layer in an OLED Device”. Donor element 100 is then heated by applied radiation, such as by laser beam 175 from laser 165, through transparent portion 183. Donor element 100 is heated by the radiation, transferring coated emissive material 125 from donor element 100 to substrate 20, as described by Phillips, et al. In the current invention, it is not necessary to transfer emissive material 125 in a pattern, as the entire layer of emissive material 125 is transferred to substrate 20. Because the entire layer is transferred, it will be understood that it is not necessary to have a precise radiation source such as laser 165. For example, a broad-area flash lamp can be used.

After irradiation is complete, transfer apparatus 185 is opened and donor element 100 and substrate 20 can be removed via load lock 157. Alternatively, donor element 100 can be removed via load lock 157 while substrate 20 is left in place. The transfer process can then be repeated using substrate 20 and a new donor element 100.

It will be clear that variations on this procedure can be effected. Substrate 20 can be coated at coating station 160 with additional layers of materials useful in OLED fabrication. Such coating can occur before, after, or both before and after the radiation-induced transfer. For example, a substrate 20 can have successively applied to it a hole-transporting layer 40 at coating station 160, an emissive material at transfer station 170, and an electron-transporting layer 55 at coating station 160.

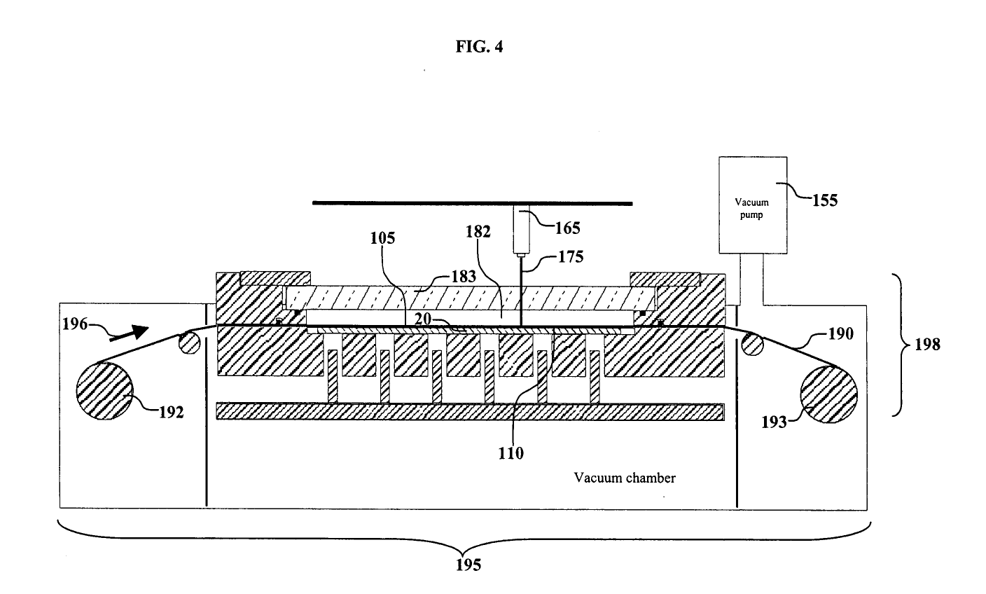

Turning now to FIG. 4, there is shown a cross-sectional view of another embodiment of an apparatus for use in this invention wherein the donor element is a flexible web that can be moved into a transfer position relative to an OLED substrate so that emissive material can be transferred to the substrate. Transfer apparatus 198 has been described in detail in commonly assigned U.S. patent application Ser. No. 10/224,182 filed Aug. 20, 2002 by Bradley A. Phillips, et al., entitled “Apparatus for Permitting Transfer of Organic Material from a Donor Web to Form a Layer In an OLED Device”. Transfer apparatus 198 is shown in a closed position, but it also has an open position for loading and unloading OLED substrate 20 and for moving flexible web 190. Flexible web 190 is precoated with emissive material 125 and is initially stored on donor roll 192, and is fed in direction of travel 196 to take-up roll 193 during operation of transfer apparatus 198. Vacuum chamber 195 is held under vacuum by vacuum pump 155. Transparent portion 183 forms part of pressure chamber 182, which holds flexible web 190 in a transfer position with OLED substrate 20. By transfer position, it is meant that flexible web 190 and OLED substrate 20 are held relative to each other so that a position of direct contact or a controlled separation relative to each other is ensured. Irradiation of flexible web 190, e.g. by laser beam 175 from laser 165, against non-transfer surface 105 of flexible web 190 effects transfer of emissive material 125 from transfer surface 110 of flexible web 190 to OLED substrate 20 over any other layers (e.g. hole-transporting layer 40) already coated on substrate 20.

Flexible web 190 can be coated with a single layer of transferable emissive material 125 for transfer to a series of OLED substrates 20. In an alternate embodiment, flexible web 190 can have a series of coated patches of transferable emissive material 125, each at least as large as substrate 20. Each patch can be sequentially moved to the transfer position with OLED substrate 20 and heated by radiation to cause material transfer. In this case, two or more layers of emissive material 125 can be sequentially transferred to OLED substrate 20. The different patches can include different emissive materials. For example, a first coated patch of transferable emissive material 125 can include a light-emitting yellow dopant for forming a yellow light-emitting layer, while a second coated patch of transferable emissive material 125 can include a light-emitting blue dopant for forming a blue light-emitting layer. Together, the two layers can comprise a light-emitting OLED device which is capable of emitting white light.

In an alternate embodiment, flexible web 190 can be a continuous sheet. This can be accomplished by the use of coating and cleaning stations for flexible web 190 inside vacuum chamber 195 or a related chamber. Such an apparatus has been described by Boroson, et al. in commonly assigned U.S. Pat. No. 6,555,284.

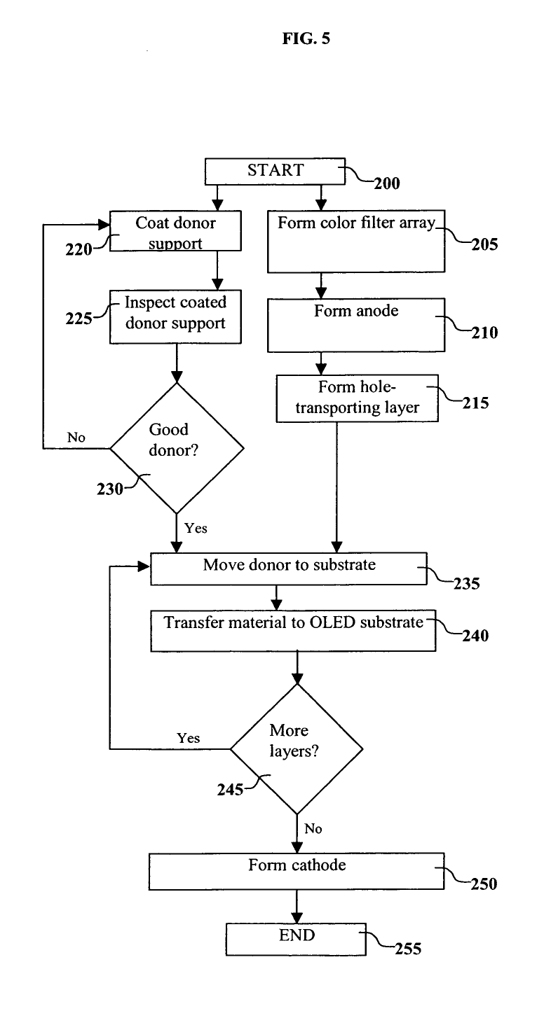

Turning now to FIG. 5, there is shown a block diagram of one embodiment of a method of manufacturing an OLED device according to this invention. At the start (Step 200), a color filter array (e.g. color filters 25a, 25b, and 25c) is formed on one surface of an OLED substrate 20 (Step 205). Then a series of anodes (e.g. anodes 30a, 30b, and 30c) is formed by an evaporation process on the same surface or on the second surface of the substrate 20 (Step 210), followed by forming by an evaporation process a hole-transporting layer 40 over the surface of the anodes (Step 215).

At another station, or in another apparatus, a donor support 115 is coated with a layer of emissive material 125 (Step 220) by transferring to donor support 115 heat-transferable materials which are capable of forming a white light-emitting layer in an OLED device, forming a donor element 100, which is a coated donor support. The coated donor support is then inspected (Step 225). Inspecting coated donor support 100 can be done by various methods, such as in-situ spectroscopic ellipsometry or other methods as taught in commonly assigned U.S. patent application Ser. No. 10/647,499 filed Aug. 25, 2003 by Giana M. Phelan, et al., entitled “Correcting Potential Defects in an OLED Device”. If the quality of coated donor support 100 is insufficient for manufacturing an OLED device (Step 230), the donor element is rejected and another donor support 115 is coated. If the quality of coated donor support 100 is sufficient for manufacturing an OLED device, it is passed to the following material transfer step. Steps 220 to 230 can be done before, after, or simultaneously with Steps 205 to 215.

The donor element 100 is then moved into a transfer position with hole-transporting layer 40 of OLED substrate 20 (Step 235). Emissive material 125 is then transferred from donor element 100 to the OLED substrate 20 by treatment with radiation such as laser beam 175 (Step 240), forming a light-emitting layer (e.g. light-emitting layer 50). If emissive material 125 comprises a mixture of two or more transferable colorant components, e.g. a layer with a light-emitting yellow dopant and a layer with a light-emitting blue dopant, they can form a single white light-emitting layer for an OLED device when transferred via this process. If there are more emissive layers to be coated (Step 245), Steps 235 and 240 are repeated. This can be done by moving a new donor element 100 into a transfer position with substrate 20 in Step 235. If the coated donor support is in the form of a flexible web 190, a series of coated patches of transferable emissive material 125 can be sequentially moved to the transfer position (Step 235) and heated by radiation to cause material transfer (Step 240) to form a light-emitting layer which is capable of emitting white light. If no more emissive layers are to be coated, a cathode 90 is then coated by an evaporation process over light-emitting layer 50 on OLED device 10 (Step 250). The process end at transfer station 255. Other steps are also possible. For example, a hole-injecting layer 35 as already described can be deposited between Steps 210 and 215. An electron-transporting layer 55 and/or an electron-injecting layer 60 can be deposited between Steps 245 and 250.

The invention has been described in detail with particular reference to certain preferred embodiments thereof, but it will be understood that variations and modifications can be effected within the spirit and scope of the invention.

### Parts List

10 OLED device
20 substrate
25a red color filter
25b green color filter
25c blue color filter
30a anode
30b anode
30c anode
35 hole-injecting layer
40 hole-transporting layer
45 light-emitting layer
50 light-emitting layer
55 electron-transporting layer
60 electron-injecting layer
70 organic EL element
90 cathode
100 donor element or coated donor support
105 non-transfer surface
110 transfer surface
115 donor support
120 radiation-absorbing material
125 emissive material
150 vacuum coater
150a coating chamber
150b transfer chamber
155 vacuum pump
156 load lock
157 load lock

### Parts List (con't)

158 load lock
160 coating station
165 laser
170 transfer station
172 support
175 laser beam
180 coating apparatus
182 pressure chamber
183 transparent portion
185 transfer apparatus
190 flexible web
192 donor roll
193 take-up roll
195 vacuum chamber
196 direction of travel
198 transfer apparatus
200 block
205 block
210 block
215 block
220 block
225 block
230 block
235 block
240 block
245 block
250 block
255 block

1. A method of making an OLED device comprising:
a) forming a color filter array over one surface of a substrate;
b) forming by an evaporation process an anode over the second surface of the substrate and a hole-transporting layer over the anode;
c) moving one or more coated donor elements into a transfer position relative to the hole-transporting layer and transferring emissive material from the donor elements onto the hole-transporting layer to form a light-emitting layer which is capable of emitting white light; and
d) coating by an evaporation process a cathode over the light-emitting layer.

2. The method of claim 1 wherein the donor element is a flexible web having a series of coated patches of transferable emissive material which are sequentially moved to the transfer position and heated by radiation to cause material transfer.

3. A donor element comprising a donor support, and a layer formed over the support having a mixture of two transferable colorant components which, when transferred, will form a single white light-emitting layer for an OLED device.

4. In a method of manufacturing an OLED device, which emits white light, comprising:
a) providing a flexible donor support, and transferring to such donor support heat-transferable materials which are capable of forming a white light-emitting layer in an OLED device, and
b) inspecting the coated donor support prior to material transfer.
